(19) United States
(12) Patent Application Publication
(10) Pub. No.: US 2014/0369455 A1
(43) Pub. Date: Dec. 18, 2014

(54) Data Driven Step Counter for Rod Control Systems of Nuclear Power Plants

(71) Applicant: Analysis and Measurement Services Corporation, Knoxville, TN (US)

(72) Inventors: Jacob R. McCulley, Knoxville, TN (US); Samuel D. Caylor, Knoxville, TN (US); Hashem M. Hashemian, Knoxville, TN (US)

(21) Appl. No.: 13/920,667

(22) Filed: Jun. 18, 2013

(51) Int. Cl. G21C 17/00

(52) U.S. Cl. CPC G21C 17/00
USPC 376/245

(57) ABSTRACT

Systems and methods of monitoring step movements of control rods of a nuclear power plant, including measuring output signals of a plurality of rod movement coils during a step movement sequence of one or more control rods, analyzing the output signals to determine a direction of the step movement sequence, and comparing one or more output signals to reference output sequence to verify that a step of the control rod has occurred.

### FIELD OF INVENTION

The present application relates generally to nuclear reactor rod control systems, and more particularly relates to systems and methods of confirming rod movement, determining step movements, and providing step indication of control rods in nuclear power plants.

### BACKGROUND

In a nuclear Pressurized Water Reactor (PWR), the power level of the reactor is controlled by inserting and retracting control rods, which may include shutdown rods, in a reactor core.

Current designs of many nuclear power plants are equipped with control and shutdown rods which are inserted and withdrawn from the reactor core to control the reactivity by absorbing neutrons. Specifically, in Pressurized Water Reactors (PWRs), the movement of each rod is facilitated by its own electromechanical magnetic jack mechanism located atop the reactor vessel. Two examples of rod control systems that use this mechanism are the Control Rod Drive Mechanism (CRDM) and Control Element Drive Mechanism (CEDM). Both of these mechanisms consist of a set of coils that provide precise vertical movement to the rod by sequentially inducing a magnetic field in the coils to operate the mechanical parts of the system. The magnetic flux provides the energy needed to hold, insert, or withdraw the rod from the reactor core.

Existing methods make count steps based on demands from the control room. The method proposed herein makes an assessment of rod movement from the output of the rod movement mechanism. This allows steps to only be counted when movement actually occurs based on verification of a proper rod movement sequence. This method will help mitigate step count errors which can cause reactor trips.

### BRIEF SUMMARY

Example embodiments of the present general inventive concept provide systems and methods of verifying proper step movements of control rods in nuclear power plants.

Additional features and embodiments of the present general inventive concept will be set forth in part in the description which follows and, in part, will be obvious from the description, or may be learned by practice of the present general inventive concept.

Example embodiments of the present general inventive concept can be achieved by providing a method of monitoring step movements of control rods of a nuclear power plant, including measuring output signals of a plurality of rod movement coils during a step movement sequence of one or more control rods, analyzing the output signals to determine a direction of the step movement sequence, and comparing one or more output signals to the reference rod movement sequence to verify that a step of the control rod has occurred.

Verification of the step movement includes verification of sequencing, timing, and mechanical operation of the rod control mechanism as related to the reference rod movement sequence.

The method may include decrementing or incrementing a step counter based on the analyzing and comparing operations.

The method may include generating a warning signal if a determined direction of step movement does not correspond to a commanded direction of step movement and/or if a difference between the one or more output signals deviates from the reference rod movement sequence by a predetermined amount.

The method may include displaying step information.

Example embodiments of the present general inventive concept can also be achieved by providing a step counter system for a rod control system of a nuclear power plant, including a measuring unit to measure output signals of a plurality of rod movement coils during a step movement sequence of one or more control rods, and a controller to analyze the output signals to determine a direction of the step movement sequence, and to compare one or more output signals to the reference rod movement sequence to verify that a step of the control rod has occurred.

The controller can be configured to decrement or increment a step counter based on a determined direction of the step movement sequence and a comparison of the one or more output signals to the reference rod movement sequence.

The controller can be configured to generate a warning signal if a determined direction of step movement does not correspond to a commanded direction of step movement and/or if a difference between the one or more output signals deviates from the reference signal by a predetermined amount.

The step counter may include a display unit to display step counter information based a determined direction of the step movement sequence and a comparison of the one or more output signals to the reference rod movement sequence.

### BRIEF DESCRIPTION OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a schematic block diagram of a rod position control system for a pressurized water reactor according to an example embodiment of the present general inventive concept;

FIG. 2 is a cross sectional block diagram of a Control Rod Drive Mechanism (CRDM) system according to an example embodiment of the present general inventive concept;

FIG. 3 is a cross sectional block diagram of a Control Element Drive Mechanism (CEDM) according to an example embodiment of the present general inventive concept;

FIG. 4 is a block schematic diagram of a rod control system for a CRDM according to an example embodiment of the present general inventive concept;

FIG. 5 is an example of CRDM currents for a withdrawal sequence according to an example embodiment of the present general inventive concept;

FIG. 6 illustrates a block diagram of a data driven step counter system according to an example embodiment of the present general inventive concept; and

FIG. 7 illustrates a timing diagram of an embodiment of CRDM current signals for an insertion and withdrawal sequence according to an example embodiment of the present general inventive concept.

### DETAILED DESCRIPTION

Reference will now be made to example embodiments of the present general inventive concept, examples of which are illustrated in the accompanying drawings and illustrations. The example embodiments are described herein in order to explain the present general inventive concept by referring to the figures.

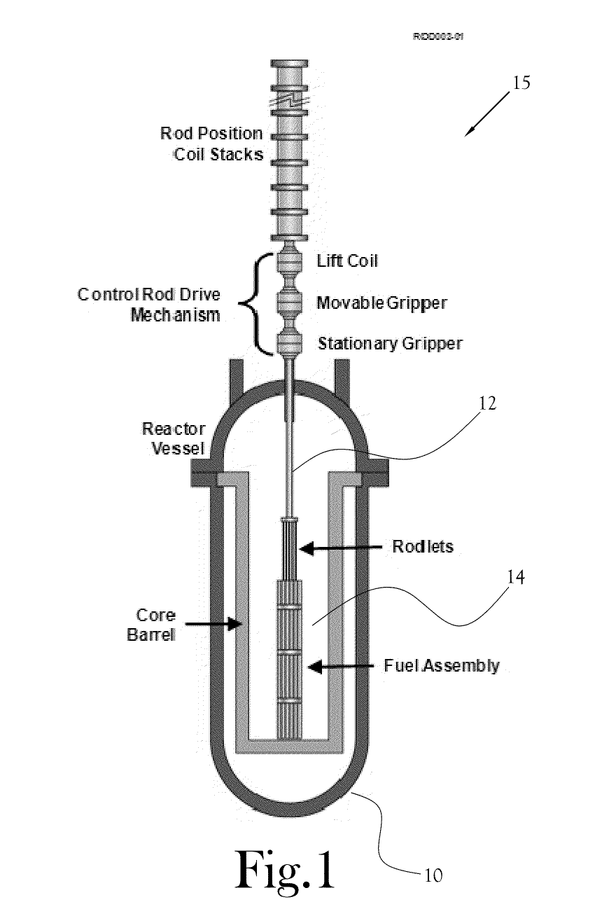

FIG. 1 is a schematic block diagram of a rod position control system for a pressurized water reactor according to an example embodiment of the present general inventive concept. Referring to FIG. 1, the power level of the reactor 10 is controlled by inserting and retracting control rods 12 (which may include the shutdown rods) into the reactor core 14 to control the reactivity by absorbing neutrons. Movement of each rod may be facilitated by its own electromechanical magnetic jack mechanism located atop a reactor vessel referred to as a rod control system (15).

In the embodiment of FIG. 1, the control rods are moved by a Control Rod Drive Mechanism (CRDM) including electromechanical jacks to raise or lower the control rods in increments. The CRDM may include a lift coil, a moveable coil, and a stationary coil controlled by a Rod Control System (RCS), and a ferromagnetic drive rod coupled to the control rod to move within a pressure housing 16. The drive rod may include a number of circumferential grooves at intervals (“steps”) that define a range of movement for the control rod. An example interval may be ⅝ inch. An example drive rod may contain approximately 231 grooves, which may vary. A moveable gripper mechanically engages the grooves of a drive rod when its coil is energized, and disengages from the drive rod when the coil is de-energized. Energizing a lift coil raises the moveable gripper and the associated control rod if the moveable coil is energized by one step. Energizing the moveable coil and de-energizing the lift coil moves the control rod down one step. Similarly, when energized, a stationary gripper engages the drive rod to maintain the position of the control rod and, when de-energized, disengages from the drive rod to allow the control rod to move.

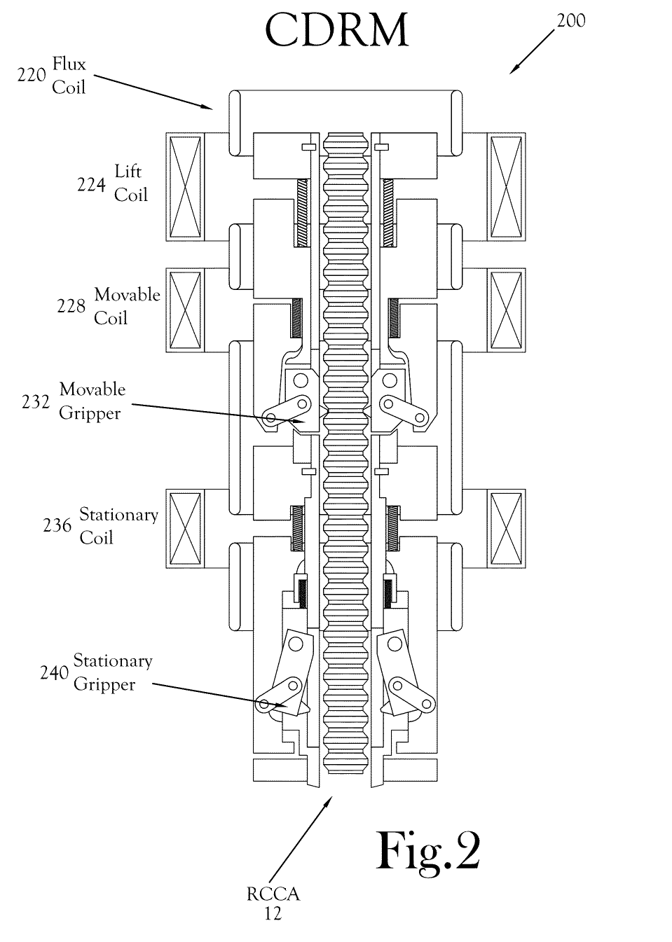

FIG. 2 is a cross sectional block diagram of a Control Rod Drive Mechanism (CRDM) system according to an example embodiment of the present general inventive concept. As illustrated in FIG. 2, an example CRDM comprises three electric coils (Lift, Movable and Stationary) and two electromagnetic jacks with grippers (Movable and Stationary). The drive rod is grooved which allows the grippers to engage and support the weight of the rod. These grooves allow the mechanism to insert and withdraw the rod in ⅝″ steps.

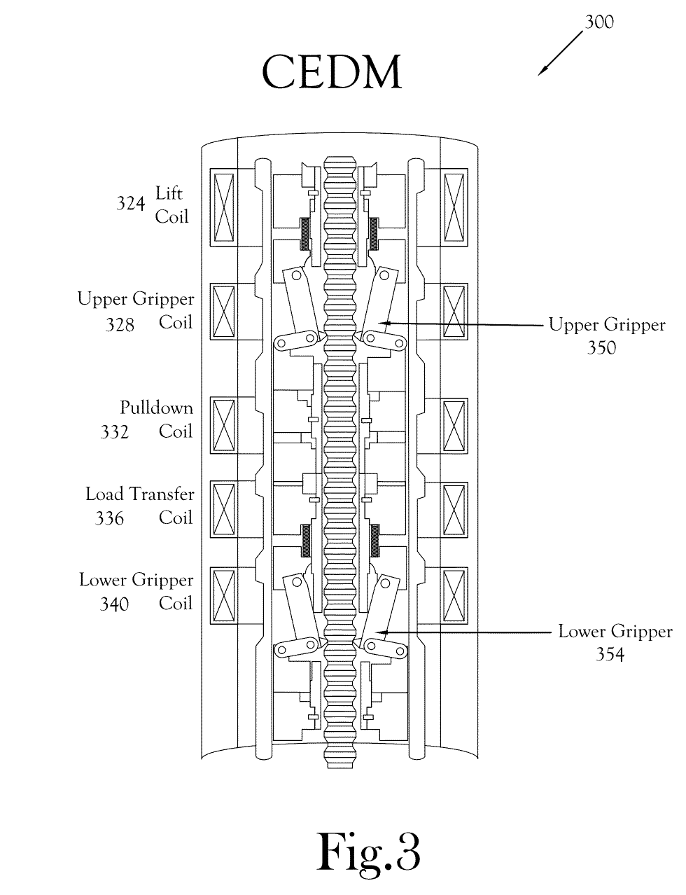

FIG. 3 is a cross sectional block diagram of a Control Element Drive Mechanism (CEDM) according to an example embodiment of the present general inventive concept. As illustrated in FIG. 3, CEDM design may comprise of five electric coils (Lift, Upper Gripper, Pull down, Load Transfer, and Lower Gripper) and two electromagnetic jacks with grippers (Upper and Lower). The drive rod for this system is grooved to allow the rod to insert or withdraw from the reactor core in steps when the coils are energized in a particular sequence. An example step interval is ¾″.

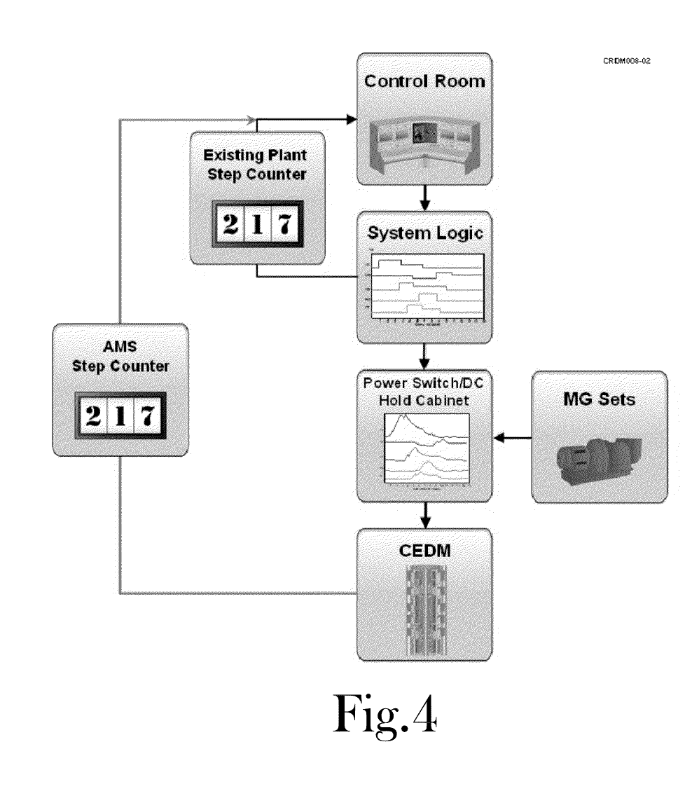

FIG. 4 is a block schematic diagram of a rod control system for a CRDM according to an example embodiment of the present general inventive concept. Referring to FIG. 4, an example rod control system comprises controls and indicators in the main control room, control logic cabinets, power switching cabinets, power distribution from the motor generator sets, and the rod control mechanism itself. The rod movement demand, generated by either the operator or the reactor control system, is received and processed by the cabinet logic. The logic cabinet then controls the power switching circuitry that is responsible for the motion of the rod control mechanism. There are currently three different power levels that the switching circuitry provides to the drive mechanism. These power levels include the ‘High’ state, which is used to quickly energize the coil, ‘Reduced’, which is used to maintain the energized state, and ‘Low’, which is used for the coil in the off state. The logic cabinet is responsible for providing the sequence at which these power levels should be applied to the coils for the desired rod movement. The RCS may include a logic cabinet and a power cabinet. The logic cabinet may receive manual demand signals from an operator or automatic demand signals from a reactor control and provides command signals needed to operate shutdown and control rods according to a predetermined schedule. The power cabinet provides a programmed current. The sequencing is established by the logic cabinet through a set of current orders which are provided to the power cabinet firing and regulation cards for low, reduced, or full levels of current to be applied to the coils.

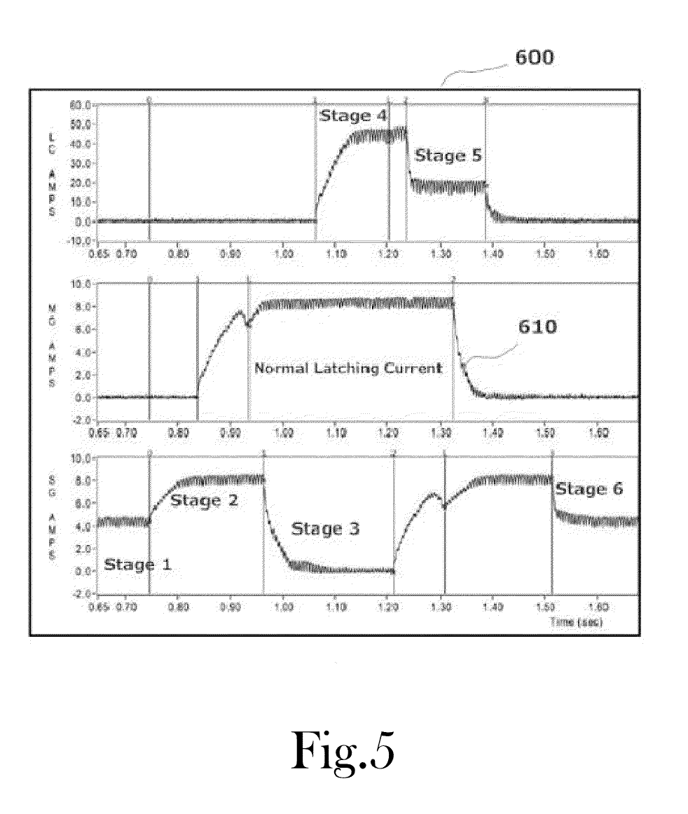

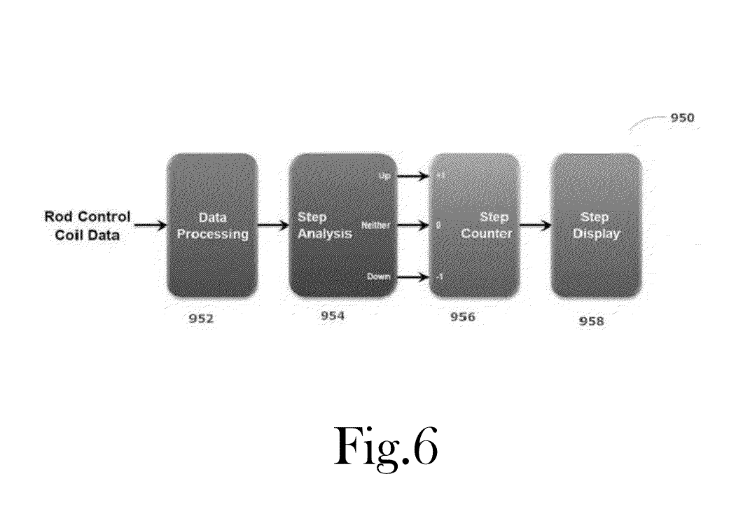

FIG. 5 is an example of CRDM currents for a withdrawal sequence according to an example embodiment of the present general inventive concept. As illustrated in FIG. 6, the coil current data embodies information that can be used to determine proper rod movement and operation. For example, the latching of the stationary and moveable gripper can be confirmed in the coil current data. A rod latching problem could result in a rod slipping or dropping causing the step count in the control room to become unreliable. The current diagram 600 shows a normal current 610 trace when the rod is withdrawn from a reactor vessel as requested from the control signals illustrated in FIG. 5.

Referring to FIG. 5, during a Stage 1, a Stationary Gripper (SG) coil is energized to a reduced current, wherein the SG is the only gripper supporting the rod shaft. In a Stage 2, the SG coil is energized to full, while a Moveable Gripper (MG) coil energizes and latches to the rod shaft. In a Stage 3, the SG coil discharges to an inactive state so that the rod load is transferred completely to the MG. In a Stage 4, the Lift Coil (LC) is energized to full until the rod shaft is lifted a predetermined amount. In a Stage 5, the LC is reduced until the SG coil energizes and latches the gripper again. In a Stage 6, once the SG is latched, the LC and MG disengage, the SG coil discharges to reduced current and the CRDM is returned to Stage 1.

Presently, step counters that are used to display the current step of the drive mechanism are based on up or down rod movement commands coming from either the reactor operator or reactor control system. Since the step counter is based on demanded movement, and not actual movement, the information may become inaccurate if a problem occurs in the drive mechanism or rod control system. An example solution is with a data driven solution that uses the outputs of the drive mechanism coils to confirm rod movement and determine the step of the rod.

FIG. 6 illustrates a block diagram of a data driven step counter system according to an example embodiment of the present general inventive concept. In this embodiment, the data driven step counter applies advanced analysis techniques to signals acquired from existing plant test points so that no additional sensors are required to confirm the actual movement of the rod. The counter is configured to detect the beginning of a new rod movement event. The raw data from drive mechanism can then be processed 952 to prepare it for step analysis 954. In some embodiments, the step analysis determines the direction of the step, validates the sequencing, verifies that the latches have properly engaged, and confirms that the LC properly lifts its responsible gripper assembly. If the step analysis concludes that an insert or withdraw movement has actually occurred, the step counter will be decremented or incremented respectively. If the step analysis detects an error with the sequence, latching, or movement of the rod, the step counter can remain on its current step and a warning can be provided. The step counter stores the current step and sends the step information to the step display 958. The step display provides step indication for all drive mechanisms.

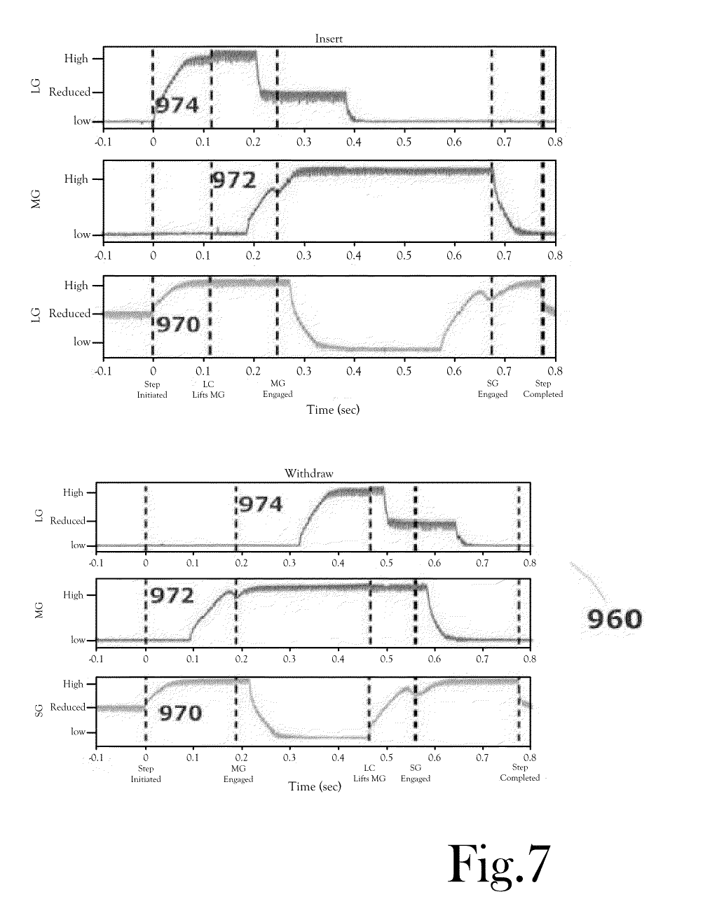

FIG. 7 illustrates a timing diagram of an embodiment of CRDM current signals for an insertion and withdrawal sequence according to an example embodiment of the present general inventive concept. Example embodiments of the data driven step counter can determine the direction of the step based on the initial condition of the step. For example, with the CRDM system as illustrated in FIG. 7, steps start with the SG going ‘High’ 970 and the direction can be determined based on the states of the other two coils. If the MG engages prior to the LC going high, the step can be determined to be a withdrawal. If the LC is energized high 974 before the MG engages, the step can be determined to be an insertion. Thus, the step direction can be determined from the coil output data.

Referring to FIG. 7, the counter can be configured to verify that the sequence for the demanded direction was correct before the step can be considered. Using a CRDM as an example, if the LC engages too late during an insertion sequence it could actually cause the rod to move in the wrong direction. Therefore, in some embodiments, the data from the coil outputs can be used to verify the sequence of the ‘High’, ‘Reduced’, and low' states from each of the coils and, consequently, to determine if a step could have occurred. The CEDM and CRDM rod control systems consist of different components and both utilize a particular sequence of events in order to move the rod in the demanded direction. However, the methods are not limited to the sequences described in this example. For example, some plants have implemented a double gripper modification for the CRDM which allows both the MG and SG to support the weight of the rod during a hold state. Although such modifications may change the sequence of events used by the CRDM to complete a step, the example systems and methods of the present general inventive concept can still be applied for considering the rod movement.

In some embodiments, verifying the sequencing of the coil states alone may not be enough to verify that a step of the drive rod has occurred. For example, the latching of the magnetic jacks may be confirmed as well as the times at which the latches occur. Moreover, the coil(s) associated with a given gripper may go to a high state but that does not guarantee that the latch was properly engaged. To verify the latch engagement, embodiments of the present general inventive concept examine the phenomena which causes the latch ‘dip’ in the coil output data. That is, when a gripper coil has enough energy it causes the gripper assembly to be slightly lifted causing the gripper to engage the grooved rod. The upward movement of the gripper causes a back EMF to be induced in the coil which causes the latch ‘dip’ seen on the coil current data. For example, if the lift coil cannot perform the lift movement over the distance required to complete one step the rod will most likely remain on the current step. Additionally, if the rod becomes stuck, LC only partially lifts the gripper assembly, or some other obstacle hinders the grippers to fully engage or disengage it will be detected in the gripper movement analysis. Further analysis of this change in current can verify that the grippers have been fully engaged or disengaged, and that the lift coils have properly lifted the gripper assembly for which they are responsible. The time at which the latch has been engaged should also be compared to other critical events in the coil sequence. For instance, if the MG disengages prior to the SG engaging in the step of the CRDM, then the rod may slip or completely be dropped into the reactor core.

An example method of monitoring step movements of control rods of a nuclear power plant, comprises: measuring output signals of a plurality of rod movement coils during a step movement sequence of one or more control rods; analyzing the output signals to verify the rod movement; and analyzing the output signals to determine a direction of the step movement sequence. An example method further comprises verifying step movement sequence. An example method further comprises verification of mechanical movement of the mechanism as it relates to the rod step movement sequence. An example method further comprises decrementing or incrementing a step counter based on the analyzing and comparing operations. An example method further comprises generating a warning signal if a determined direction of step movement does not correspond to a commanded direction of step movement and/or if a difference between the one or more output signals deviates from the reference signal by a predetermined amount. An example method further comprises displaying step information.

An example step counter system for a rod control system of a nuclear power plant, comprises: a measuring unit to measure output signals of a plurality of rod movement coils during a step movement sequence of one or more control rods; and a controller to analyze the output signals to determine a direction of the step movement sequence, analyzing the output signals to verify the rod movement. An example controller is configured to decrement or increment a step counter based on a determined direction of the step movement sequence and a comparison to one or more output signals of the reference output signal. An example controller is configured to generate a warning signal if a determined direction of step movement does not correspond to a commanded direction of step movement and/or if a difference between the one or more output signals deviates from the reference sequence by a predetermined amount. An example system further comprises a display unit to display step counter information based a determined direction of the step movement sequence and verification through a comparison of the one or more output signals to the reference rod movement sequence.

The examples described herein provide a metric which may be utilized to diagnose rod movement problems because the calculation results may be predictable from step to step wherein a significant variation from normal may be noticed because a problem, such improper rod movement, exists.

While embodiments of the present general inventive concept are described herein, it is not the intention of the applicant to restrict or in any way limit the scope of the appended claims to such detail. Additional modifications will readily appear to those skilled in the art. The present general inventive concept in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method of monitoring step movements of control rods of a nuclear power plant, comprising:
measuring output signals of a plurality of rod movement coils during a step movement sequence of one or more control rods;
analyzing the output signals to verify the rod movement and determine a direction of the step movement sequence.

2. The method of claim 1, further comprising verifying the step movement sequence.

3. The method of claim 1, further comprising the verification of rod movement timing as it relates to the step movement sequence.

4. The method of claim 1, further comprising the verification of mechanical movement of the mechanism as it relates to the step movement sequence.

5. The method of claim 1, further comprising decrementing or incrementing a step counter based on the analyzing and comparing operations.

6. The method of claim 1, further comprising generating a warning signal if a determined direction of step movement does not correspond to a commanded direction of step movement and/or if a difference between the one or more output signals deviates from the reference signal by a predetermined amount.

7. The method of claim 4, further comprising displaying step information.

8. A step counter system for a rod control system of a nuclear power plant, comprising:
a measuring unit to measure output signals of a plurality of rod movement coils during a step movement sequence of one or more control rods; and
a controller to analyze the output signals to determine a direction of the step movement sequence, analyzing the output signals to verify the rod movement.

9. The step counter system of claim 8, wherein the controller is configured to decrement or increment a step counter based on a determined direction of the step movement sequence and a comparison to one or more output signals of the reference output signal.

10. The step counter system of claim 8, wherein the controller is configured to generate a warning signal if a determined direction of step movement does not correspond to a commanded direction of step movement and/or if a difference between the one or more output signals deviates from the reference sequence by a predetermined amount.

11. The step counter system of claim 8, further comprising a display unit to display step counter information based a determined direction of the step movement sequence and verification through a comparison of the one or more output signals to the reference rod movement sequence.
